(19) United States
(12) Patent Application Publication
(10) Pub. No.: US 2023/0254394 A1
(43) Pub. Date: Aug. 10, 2023

(54) CUP HOLDER ATTACHMENT FOR PROPPING A CELL PHONE

(71) Applicant: Khuong Nguyen, Marietta, GA (US)

(72) Inventor: Khuong Nguyen, Marietta, GA (US)

(21) Appl. No.: 18/301,861

(22) Filed: Apr. 17, 2023

Related U.S. Application Data
(63) Continuation-in-part of application No. 17/469,204, filed on Sep. 8, 2021.
(60) Provisional application No. 63/077,379, filed on Sep. 11, 2020.

(51) Int. Cl. H04M 1/04; B65D 51/24

(52) U.S. Cl. CPC H04M 1/04; B65D 51/24

(57) ABSTRACT

A cup holder attachment for propping up a cell phone at a viewable angle. The attachment may comprise a cup filled with a weighted material and configured to fit into a cup holder. The attachment may further comprise a lid comprising a rod hole and an indentation for holding the cell phone. The attachment may further comprise a rod disposed through the rod hole, such that a first end of the rod is buried in the weighted material and a second end of the rod protrudes from the lid. The attachment may further comprise a supporter attached to the second end of the rod. The supporter may be capable of supporting the cell phone.

### CROSS-REFERENCES TO RELATED APPLICATIONS

This application is a continuation-in-part and claims benefit of U.S. Non-Provisional application Ser. No. 17/469,204 filed Sep. 8, 2021, which claims benefit of U.S. Provisional Application No. 63/077,379 filed Sep. 11, 2020, the specification of which is incorporated herein in their entirety by reference.

### FIELD OF THE INVENTION

The present invention is directed to a cup holder attachment for propping up a cell phone at a viewable angle.

### BACKGROUND OF THE INVENTION

In the United States, 1 out of every 4 car crashes are related to distractions caused by looking at or using a cell phone. To reduce the risk of this life-threatening compulsion, several devices have been employed to allow people to quickly check or use their phones while driving without the need for them to pull their phone out of their pockets or hold it in their hands instead of keeping both hands on the wheel. One such device comprises a magnetic clip that attaches to a car's air conditioning vent, and a flat magnet that is placed on a back of a cell phone within a phone case, thus allowing the phone to be magnetically held up at the air conditioning vent. While this device is useful for keeping the cell phone at eye level, the limitations of this device are numerous. For example, the device inherently blocks one of the air conditioning vents of the car, reducing overall air circulation. Furthermore, people who wish to prop their phone up but do not have their own specially designed magnet within their phone case would be unable to use the device. Thus, a present need exists for a device that allows a phone to be propped up for easy use and viewing without blocking an air conditioning vent and that can be used without difficult-to-apply special attachments.

### BRIEF SUMMARY OF THE INVENTION

It is an objective of the present invention to provide devices that allow for propping up a cell phone at a viewable angle, as specified in the independent claims. Embodiments of the invention are given in the dependent claims. Embodiments of the present invention can be freely combined with each other if they are not mutually exclusive.

The present invention features a cup holder attachment for propping up a cell phone at a viewable angle. The attachment may comprise a cup filled with a weighted material and configured to fit into a cup holder. The attachment may further comprise a lid disposed over the cup. The lid may comprise a rod hole disposed through the lid, and an indentation embedded in the lid suitable for holding the cell phone. In some embodiments, the cup may comprise a first charger hole and the lid may further comprise a second charger hole disposed in the indentation to allow for a charging cord to be run through the first and second charger holes to connect to the cell phone. The attachment may further comprise a rod disposed through the rod hole, such that a first end of the rod is buried in the weighted material and a second end of the rod protrudes from the lid. The attachment may further comprise a supporter attached to the second end of the rod. The supporter may be capable of supporting the cell phone. In some embodiments, in place of the first and second charger holes and the indentation, the lid may comprise a groove to stabilize the charging cord within the groove. The cell phone may be supported by the charging cord within the groove.

One of the unique and inventive technical features of the present invention is the specially designed lid comprising a rod hole and an indentation to support a phone. Without wishing to limit the invention to any theory or mechanism, it is believed that the technical feature of the present invention advantageously provides for a cheap and efficient way to securely prop up a phone in a cup holder without the need for additional accessories to make use of the device. None of the presently known prior references or work has the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a cup component of the cup holder attachment of the present invention.

FIG. 2 shows a top view of the cup holder attachment of the present invention. A rod hole is represented by an X.

FIG. 3 shows a side view of the cup holder attachment of the present invention in use.

FIG. 4 shows a front view of the cup holder attachment of the present invention in use.

FIG. 5 shows a side view of the cup holder attachment of the present invention comprising a lid with a groove.

FIG. 6 shows a side view of the cup holder attachment of the present invention comprising a flexible strip as a supporter.

### DETAILED DESCRIPTION OF THE INVENTION

Following is a list of elements corresponding to a particular element referred to herein:

| | |
|---|---|
| 100 | cup holder attachment |
| 200 | cup |
| 210 | first charger hole |
| 220 | circular opening |
| 300 | lid |
| 310 | rod hole |
| 320 | indentation |
| 330 | second charger hole |
| 400 | rod |
| 500 | supporter |
| 600 | cell phone |
| 610 | charging cord |
| 700 | groove |
| 800 | flexible strip |

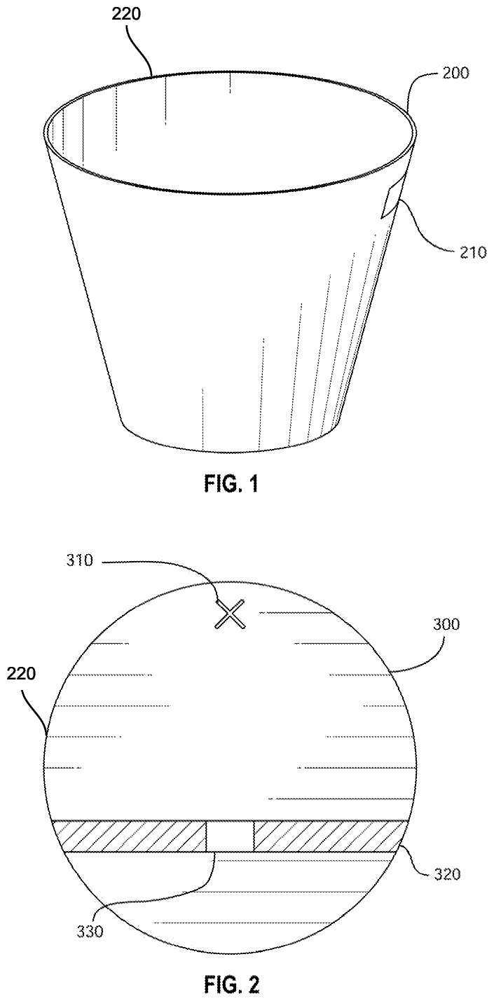

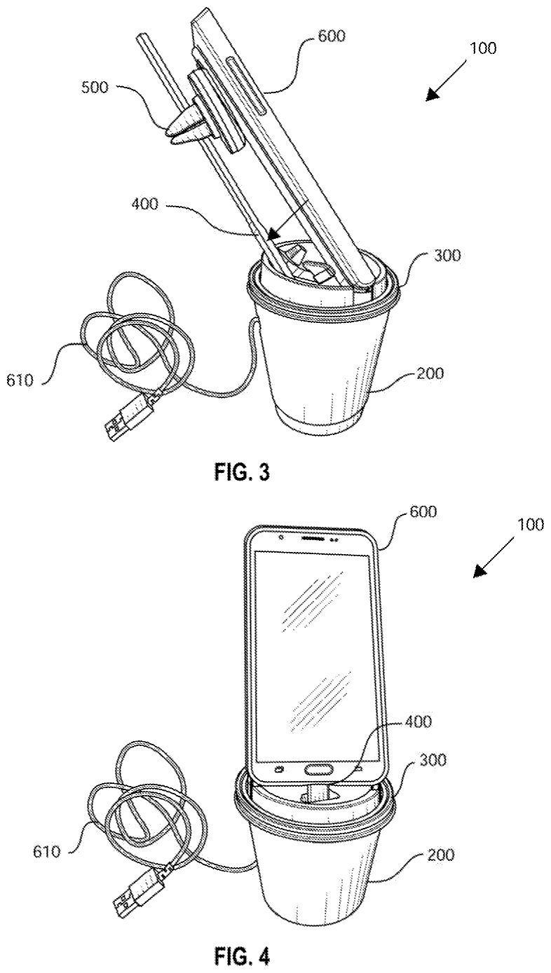

Referring now to FIGS. 1-4, the present invention features a cup holder attachment (100) for propping up a cell phone (600) at a viewable angle. In some embodiments, the attachment (100) may comprise a cup (200) filled with a weighted material. The cup (200) may be configured to fit into a cup holder. The cup (200) may comprise plastic, metal, wood, a combination thereof, or any solid material capable of holding the weighted material. The weighted material may comprise sand, water, stones, a combination thereof, or any material capable of weighing down the cup (200). In other embodiments, the cup (200) itself is heavy enough to remove the need for the weighted material. In some embodiments, the weighted material fills an entirety of the cup (200). In other embodiments, the weighted material fills a first portion of the cup (200) and a second portion of the cup (200) is empty.

The attachment (100) may further comprise a lid (300) disposed over the cup (200). The lid (300) may comprise a rod hole (310) disposed through a surface of the lid (300), and an indentation (320) embedded in the lid (300) suitable for holding the cell phone (600). The lid (300) may comprise plastic, metal, wood, a combination thereof, or any solid material capable of supporting the cell phone (600). In some embodiments, the cup (200) may comprise a first charger hole (210) disposed through a side of the cup (200) at a point above the weighted material. The lid (300) may further comprise a second charger hole (330) disposed in the indentation (320). The first charger hole (210) and the second charger hole (330) may allow for a charging cord (610) to be run through the first charger hole (210) and the second charger hole (330) to connect to the cell phone (600). This embodiment allows for the cell phone (600) to be charged while being propped up by the cup holder attachment (100). In said embodiment, the weighted material may comprise a non-liquid material.

The attachment (100) may further comprise a rod (400) disposed through the rod hole (310), such that a first end of the rod (400) is buried in the weighted material and a second end of the rod (400) protrudes from the lid (300). The rod (400) may extend through the weighted material to a bottom of the cup (200). The rod (400) may comprise bamboo or any other solid material capable of supporting the cell phone (600). In some embodiments, the rod hole (310) may comprise a hole matching a shape of the indentation (320), allowing the rod (400) to support the cell phone (600) in a plurality of configurations, for instance in both a vertical and horizontal rotation of the cell phone (600). The attachment (100) may further comprise a supporter (500) attached to the second end of the rod (400). The supporter (500) may be capable of supporting the cell phone (600) in an. In some embodiments, the supporter (500) may comprise a panel. In other embodiments, the supporter (500) may comprise a flexible strip (800) attached to a back of a case of the cell phone (600) and the supporter (500) may be removable from the rod (400). In some embodiments, the lid (300) may further comprise a drinking hole (340) and the weighted material may comprise a drinkable beverage. This embodiment of the present invention allows for a user to use the cup holder attachment (100) for both holding a beverage and propping up the cell phone (600). In some embodiments, the cup (200) may be placed in the cup holder of a car or a chair, and the cell phone (600) may be disposed in the indentation (320) and leans against the supporter (500). This may allow the user to view the cell phone (600) in the cup holder hands-free.

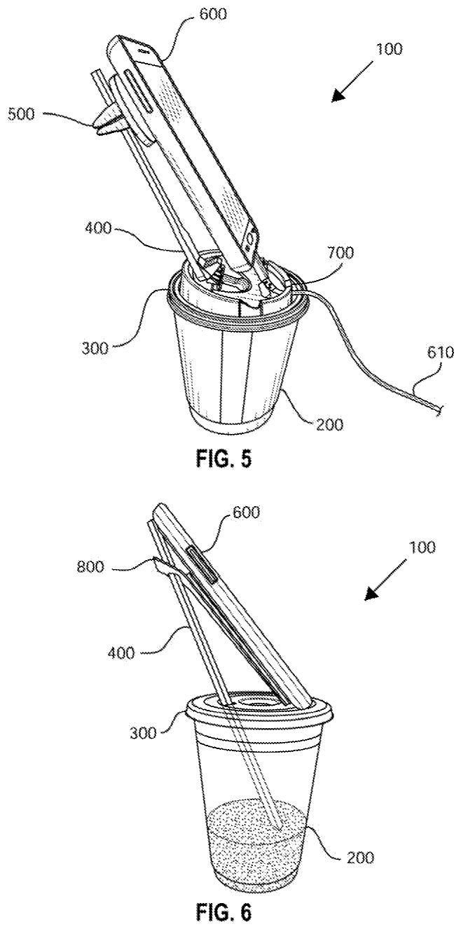

Referring now to FIG. 5, the present invention features a cup holder attachment (100) for propping up a cell phone (600) at a viewable angle. In some embodiments, the attachment (100) may comprise a cup (200) filled with a weighted material. The cup (200) may be configured to fit into a cup holder. The cup (200) may comprise plastic, metal, wood, a combination thereof, or any solid material capable of holding the weighted material. The weighted material may comprise sand, water, stones, a combination thereof, or any material capable of weighing down the cup (200). In other embodiments, the cup (200) itself is heavy enough to obviate the need for the weighted material. In some embodiments, the weighted material fills an entirety of the cup (200). In other embodiments, the weighted material fills a first portion of the cup (200) and a second portion of the cup (200) is empty.

The attachment (100) may further comprise a lid (300) disposed over the cup (200). The lid (300) may comprise a rod hole (310) disposed through a surface of the lid (300), and a groove (700) embedded in the lid (300) suitable for holding a charging cord (610). The cell phone (600) may be supported by the charging cord (610) within the groove (700). The lid (300) may comprise plastic, metal, wood, a combination thereof, or any solid material capable of supporting the cell phone (600). This embodiment allows for the cell phone (600) to be charged while being propped up by the cup holder attachment (100).

The attachment (100) may further comprise a rod (400) disposed through the rod hole (310), such that a first end of the rod (400) is buried in the weighted material and a second end of the rod (400) protrudes from the lid (300). The rod (400) may extend through the weighted material to a bottom of the cup (200). The rod (400) may comprise bamboo or any other solid material capable of supporting the cell phone (600). In some embodiments, the rod hole (310) may comprise a hole matching a shape of the groove (700), allowing the rod (400) to support the cell phone (600) in a plurality of configurations, for instance in both a vertical and horizontal rotation of the cell phone (600). The attachment (100) may further comprise a supporter (500) attached to the second end of the rod (400). The supporter (500) may be capable of supporting the cell phone (600). In some embodiments, the supporter (500) may comprise a panel. In other embodiments, the supporter (500) may comprise a flexible strip (800) attached to a back of a case of the cell phone (600) and the supporter (500) may be removable from the rod (400). In some embodiments, the lid (300) may further comprise a drinking hole (340) and the weighted material may comprise a drinkable beverage. This embodiment of the present invention allows for a user to use the cup holder attachment (100) for both holding a beverage and propping up the cell phone (600). In some embodiments, the cup (200) may be placed in the cup holder of a car or a chair, and the cell phone (600) may be disposed in the indentation (320) and leans against the supporter (500). This may allow the user to view the cell phone (600) in the cup holder hands-free.

The present invention features a cup holder attachment (100) for propping up a cell phone (600) at a viewable angle, the attachment (100) comprising a cup (200) having a capacity of 8 to 32 fluid ounces and a circular opening (220) at an upper portion of the cup (200) having a diameter of 2 to 6 inches, filled with a weighted material comprising sand, water, stones, a drinkable beverage, or a combination thereof, wherein the cup (200) is configured to fit into a cup holder of a vehicle. A material of the cup (200) may comprise metal, plastic, wood, or a combination thereof. The weighted material may fill a first portion of the cup (200) and a second portion of the cup (200) is empty, wherein the first portion of the cup (200) comprises 10 to 90 percent of the cup (200).

The attachment (100) may further comprise a first charger hole (210) disposed through a side of the cup (200) at the second portion of the cup (200), and a lid (300) disposed over the cup (200), configured to fit the circular opening (220) of the cup (200), the lid (300) comprising a rod hole (310) disposed through a surface of the lid (300), a drinking hole (340) disposed through the surface of the lid (300), an indentation (320) embedded in the lid (300) suitable for holding the cell phone (600), and a groove (700) configured to stabilize a charging cord (610) within the groove (700). The indentation (320) may form a linear track that cuts across an upper portion of the lid (300). The indentation (320) may comprise a depth of 0.25 to 0.5 inches. The rod hole (310) may comprise a hole having a rectangular shape matching a width of the linear track of the indentation (320), such that the hole allows the rod (400) and supporter (500) to support the cell phone (600) in a plurality of configurations comprising a vertical position of the cell phone (600) and a horizontal position of the cell phone (600).

The attachment (100) may further comprise a second charger hole (330) disposed in the indentation (320). The first charger hole (210) and the second charger hole (330) may be configured to allow the charging cord (610) to run through the first charger hole (210) and the second charger hole (330) to connect to the cell phone (600). The attachment (100) may further comprise a rod (400) configured to fit within the rod hole (310), disposed through the rod hole (310) such that a first end of the rod (400) is buried in the weighted material and a second end of the rod (400) protrudes from the lid (300).

The attachment (100) may further comprise a supporter (500) attached to the second end of the rod (400), comprising a panel, a flexible strip (800) comprising an adhesive, a hook and loop strip, or a combination thereof, or a combination thereof. The supporter (500) may be configured to support the cell phone (600) such that the cell phone (600) is disposed in the indentation (320) and leans against the supporter (500).

In some embodiments, the first portion of the cup (200) may comprise 10 to 90 percent of the cup (200). In some embodiments, the first portion of the cup (200) may comprise 1 to 99 percent of the cup (200). In some embodiments, the first portion of the cup (200) may comprise 100 percent of the cup (200). In some embodiments, the first portion of the cup (200) may comprise 50 percent of the cup (200).

In some embodiments, the capacity of the cup (200) may be 8 to 32 fluid ounces. In some embodiments, the capacity of the cup (200) may be 16 fluid ounces.

In some embodiments, the diameter of the circular opening (220) of the cup (200) may be 3 to 6 inches. In some embodiments, the diameter of the circular opening (220) of the cup (200) may be 4 to 7 inches.

In some embodiments, the indentation (320) may comprise a depth of 0.25 to 0.5 inches. In some embodiments, the indentation (320) may comprise a depth of 0.3 to 0.75 inches.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A cup holder attachment (100) for propping up a cell phone (600) at a viewable angle, the attachment (100) comprising:
a. a cup (200) having a capacity of 8 to 32 fluid ounces and a circular opening (220) at an upper portion of the cup (200) having a diameter of 2 to 7 inches, filled with a weighted material comprising sand, water, stones, a drinkable beverage, or a combination thereof, wherein the cup (200) is configured to fit into a cup holder of a vehicle, wherein a material of the cup (200) comprises metal, plastic, wood, or a combination thereof;
wherein the weighted material fills a first portion of the cup (200) and a second portion of the cup (200) is empty, wherein the first portion of the cup (200) comprises 10 to 90 percent of the cup (200);
b. a first charger hole (210) disposed through a side of the cup (200) at the second portion of the cup (200);
c. a lid (300) disposed over the cup (200), configured to fit the circular opening (220) of the cup (200), the lid (300) comprising a rod hole (310) disposed through a surface of the lid (300), a drinking hole (340) disposed through the surface of the lid (300), an indentation (320) embedded in the lid (300) suitable for holding the cell phone (600), and a groove (700) configured to stabilize a charging cord (610) within the groove (700);
wherein the indentation (320) forms a linear track that cuts across an upper portion of the lid (300);
wherein the indentation (320) comprises a depth of 0.25 to 0.75 inches;
wherein the rod hole (310) comprises a hole having a rectangular shape matching a width of the linear track of the indentation (320), such that the hole allows the rod (400) and supporter (500) to support the cell phone (600) in a plurality of configurations comprising a vertical position of the cell phone (600) and a horizontal position of the cell phone (600);
d. a second charger hole (330) disposed in the indentation (320);
wherein the first charger hole (210) and the second charger hole (330) are configured to allow the charging cord (610) to run through the first charger hole (210) and the second charger hole (330) to connect to the cell phone (600);
e. a rod (400) configured to fit within the rod hole (310), disposed through the rod hole (310) such that a first end of the rod (400) is buried in the weighted material and a second end of the rod (400) protrudes from the lid (300); and
f. a supporter (500) attached to the second end of the rod (400), comprising a panel, a flexible strip (800) comprising an adhesive, a hook and loop strip, or a combination thereof, or a combination thereof, wherein the supporter (500) is configured to support the cell phone (600) such that the cell phone (600) is disposed in the indentation (320) and leans against the supporter (500).

2. A cup holder attachment (100) for propping up a cell phone (600) at a viewable angle, the attachment (100) consisting:
a. a cup (200) having a capacity of 16 fluid ounces and a circular opening (220) at an upper portion of the cup (200) having a diameter of 6 inches, filled with a weighted material selected from a group consisting of sand, water, stones, a drinkable beverage, and a combination thereof, wherein the cup (200) is configured to fit into a cup holder of a vehicle, wherein a material of the cup (200) is selected from a group consisting of metal, plastic, wood, and a combination thereof;
wherein the weighted material fills a first portion of the cup (200) and a second portion of the cup (200) is empty, wherein the first portion of the cup (200) consists of 50 percent of the cup (200);
b. a first charger hole (210) disposed through a side of the cup (200) at the second portion of the cup (200);
c. a lid (300) disposed over the cup (200), configured to fit the circular opening (220) of the cup (200), the lid (300) consisting a rod hole (310) disposed through a surface of the lid (300), a drinking hole (340) disposed through the surface of the lid (300), an indentation (320) embedded in the lid (300) suitable for holding the cell phone (600), and a groove (700) configured to stabilize a charging cord (610) within the groove (700);
wherein the indentation (320) forms a linear track that cuts across an upper portion of the lid (300);
wherein the indentation (320) consists of a depth of 0.5 inches;
wherein the rod hole (310) consists of a hole having a rectangular shape matching a width of the linear track of the indentation (320), such that the hole allows the rod (400) and supporter (500) to support the cell phone (600) in a vertical position;
d. a second charger hole (330) disposed in the indentation (320);
wherein the first charger hole (210) and the second charger hole (330) are configured to allow the charging cord (610) to run through the first charger hole (210) and the second charger hole (330) to connect to the cell phone (600);
e. a rod (400) configured to fit within the rod hole (310), disposed through the rod hole (310) such that a first end of the rod (400) is buried in the weighted material and a second end of the rod (400) protrudes from the lid (300); and
f. a supporter (500) attached to the second end of the rod (400), consisting of a panel, wherein the supporter (500) is configured to support the cell phone (600) such that the cell phone (600) is disposed in the indentation (320) and leans against the supporter (500).
